(19) United States
(12) Patent Application Publication
(10) Pub. No.: US 2024/0144298 A1
(43) Pub. Date: May 2, 2024

(54) VISIBLE MARK FOR TRACKING IN ELECTRONIC COMMUNICATIONS

(71) Applicant: Validity, Inc., Boston, MA (US)

(72) Inventors: Gregory KIMBALL, Boulder, CO (US); Thomas BARTEL, Kremmling, CO (US)

(73) Assignee: Validity, Inc., Boston, MA (US)

(21) Appl. No.: 17/979,737

(22) Filed: Nov. 2, 2022

(51) Int. Cl. G06Q 30/02

(52) U.S. Cl. CPC G06Q 30/0201

(57) ABSTRACT

An apparatus is configured to configured to receive, from a sending device, an electronic communication which includes an executable code for a behavioral tracking process. The apparatus may generate a visible mark associated with an executable code for an engagement tracking process and insert the visible mark into an electronic communication so that the visible mark is accessible in display of the electronic communication. The apparatus may then transmit the electronic communication, including the visible mark and the executable code, to a user device.

### TECHNICAL FIELD

The present disclosure relates to an embedded mark which notifies a recipient of electronic communication that tracking is performed by the embedded mark.

### BACKGROUND

Conventionally, tracking markers (also referred to as tracking pixels) are embedded in an email and presented in a transparent mode to be invisible to a recipient of the email. The tracking marker is embedded into the email to track recipient engagement with the email. Engagement data is collected and provided to an external location by use of the tracking mark. The generated data may be used to provide actionable analytics to senders to optimize email engagement and so that senders better understand tracked activities, benefits, and choices made by email recipients.

### SUMMARY

In an exemplary implementation of the present disclosure, an apparatus comprises a memory, and processing circuitry configured to generate a visible mark associated with an executable code for an engagement tracking process; insert the visible mark and the executable code into an electronic communication so that the visible mark is accessible in display of the electronic communication; and transmit the electronic communication, including the visible mark and the executable code, to a user device.

In another exemplary implementation of the present disclosure, an apparatus comprises a memory, and processing circuitry configured to receive, from a sending device, an electronic communication which includes an executable code for an engagement tracking process; and transmit the electronic communication to a user device.

In another exemplary implementation of the present disclosure, a method comprises receiving, by an apparatus from a sending device, an electronic communication which includes an executable code for an engagement tracking process; and transmitting the electronic communication to a user device.

### BRIEF DESCRIPTION OF THE DRAWINGS

FIG. 1 illustrates an exemplary system utilizing a visible mark in accordance with the present disclosure;

FIG. 2 illustrates another exemplary system utilizing a visible mark;

FIG. 3A illustrates an exemplary electronic communication;

FIG. 3B illustrates another exemplary electronic communication including an executable link;

FIG. 3C illustrates an exemplary electronic communication including a visible mark;

FIG. 3D illustrates an exemplary electronic communication including a visible mark;

FIG. 4 illustrates an exemplary activated screen;

FIG. 5 illustrates an exemplary process utilizing a visible mark;

FIG. 6 illustrates another exemplary process utilizing a visible mark;

FIG. 7 illustrates another exemplary process utilizing a visible mark; and

FIG. 8 is a block diagram of processing circuitry that performs computer-based operations in accordance with the present disclosure.

### DETAILED DESCRIPTION OF THE DRAWINGS

The inventors of the present disclosure have recognized that conventional methods of hiding tracking markers embedded in email and other electronic communications has become disliked by recipients and service providers. These tracking markers are invisible to an email recipient. Typically, the marker is a single 1×1 transparent/white/blank pixel or may be hidden out of view of the recipient when the recipient views the email. The email recipient is unaware that their email engagement behavior is being collected and utilized by the email sender and, in some instances, third parties. Such data is frequently collected without the knowledge or consent of the recipient.

It is understood by the inventors that service providers have begun instituting policies to remove or deactivate such tracking markers in order to reduce data traffic and to protect user privacy. However, the inventors of the present disclosure have recognized that such actions by the service providers is problematic, as the engagement behavior of users is critical information to be utilized so as to increase recipient satisfaction with email messages and increase or optimize email engagement.

The inventors have developed new technologies included in the present disclosure to address the above issues. In particular, the inventors have developed, as in this disclosure, a system and method to utilize a visible mark which may notify email recipients that an engagement tracking process is enabled and engagement data is being collected. The visible mark intends to grab the attention of the email recipient based on its size, distinctiveness or possible notoriety of the image included in the visible mark. The visible mark may be 10×50 pixels in size or larger, but other dimensions may be used depending on factors such as (but not limited to) size and resolution of screen, distinctiveness of the image of the visible mark and content of the email. The visible mark is included in the email or other electronic communication and is visible to the recipient, thereby providing the recipient with notice that their engagement data is being tracked.

Additionally, the visible mark may be interacted with by the email recipient, activating an interface which will provide detailed information about the tracking or options for adjusting tracking settings and activation/deactivation of the engagement tracking process. Inclusion of the visible mark in email and other electronic communications allows the sender/marketer to demonstrate transparency of business practices as well as that the privacy of the recipient matters.

Hereinafter, systems, devices and methods according to the present disclosure will be described with reference to the accompanying drawings. The following discussion relates to email including a visible mark used for tracking recipient engagement with the email. However, the discussion is not limited to email and the visible mark, and references to email are intended to include other forms of electronic communication messaging directed to a recipient, such as but not limited to text message, direct message and private messages sent or accessed via software applications.

Further, discussion relating to tracking and collection of engagement data may be referred to as an engagement tracking process. However, the discussion is not limited to the tracking and collection of engagement data, and references to such tracking and collection processes are intended to include other methods and processes for the acquisition of user data yielding actionable analytics to senders to optimize email engagement.

Additionally, in the following discussion, engagement data may be data relating to user interaction with the email in which the visible mark is included. Alternatively, the engagement data may include data relating to user interaction with the device from a point of time that the email is opened until the email is closed. In some embodiments, engagement data may relate device information, device metadata, device user settings, user interface information, application information and/or user behavioral data.

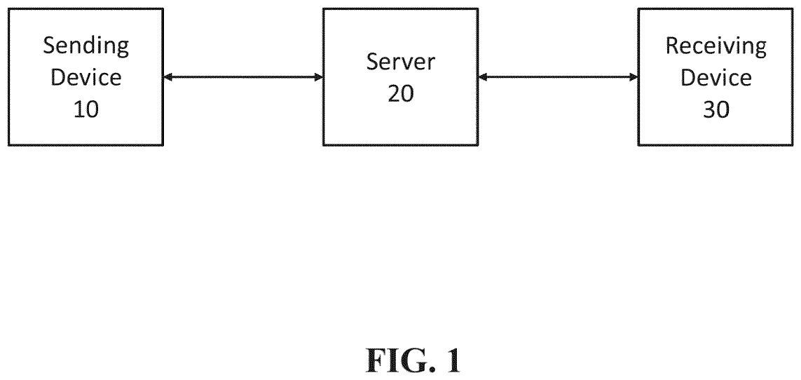

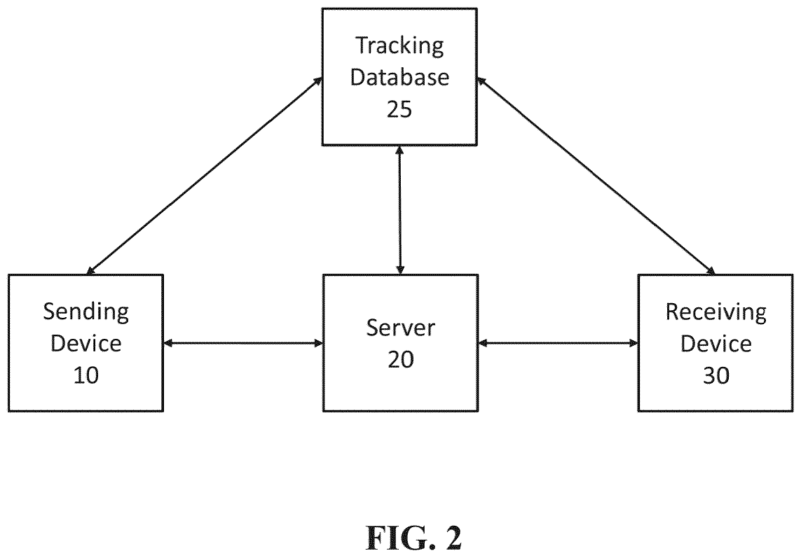

FIGS. 1 and 2 illustrate exemplary systems to utilize a visible mark in accordance with the present disclosure. Sending device 10 is an electronic device used to send an email via a network to one or more receiving device 30. Sending device 10 includes processing circuitry in order to send the email to receiving device 30 via server 20. However, in some implementations the functionality and processes of sending device 10 and server 20 are performed by a same device. And in other cases there are multiple server 20, by variable operators, operating to transmit email between sending device 10 and receiving device 30.

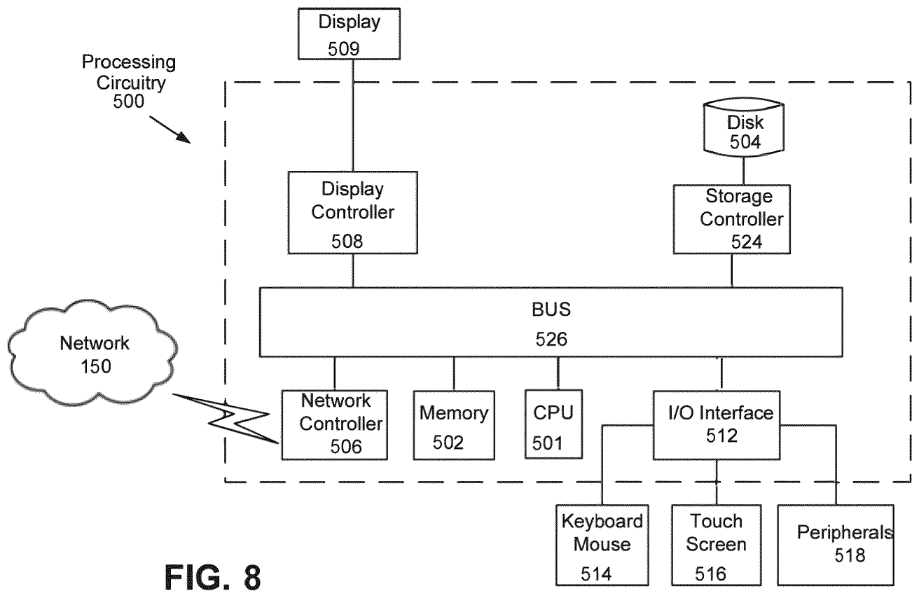

The functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. The processor may be a programmed processor which executes a program stored in a memory. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor. Details of the processing circuitry included sending device 10 will be discussed later with respect to FIG. 8.

In one implementation, the sending device 10 adds a visible mark to the email before sending the email. The user may draft or compose the email with sending device 10, or the email may be drafted or composed with another device. The sending device 10 may add the visible mark to the email after the email is drafted by a user prior to the email being sent. In another implementation, the visible mark may be included in a template of the email before the email is drafted by the user or may be added by the user to the email during drafting of the email before the email is sent. In yet another implementation, the email received by receiving device 30 may include an executable code to prompt receiving device 30 to transmit metadata to server 20, and server 20 may then send a visible mark via the network back to receiving device 30 for rendering into the email for display via a display. This allows the system to adjust the visible mark for improved visibility to the user of receiving device 30. In yet another implementation, the email received by receiving device 30 may include a visible mark for display, the receiving device 30 may send metadata to the server 20 and the server 20 may send a modified visible mark back to receiving device 30 for display with an increased likelihood of visibility. Such display emphasizes display of the visible mark to increase likelihood that a recipient notices the visible mark.

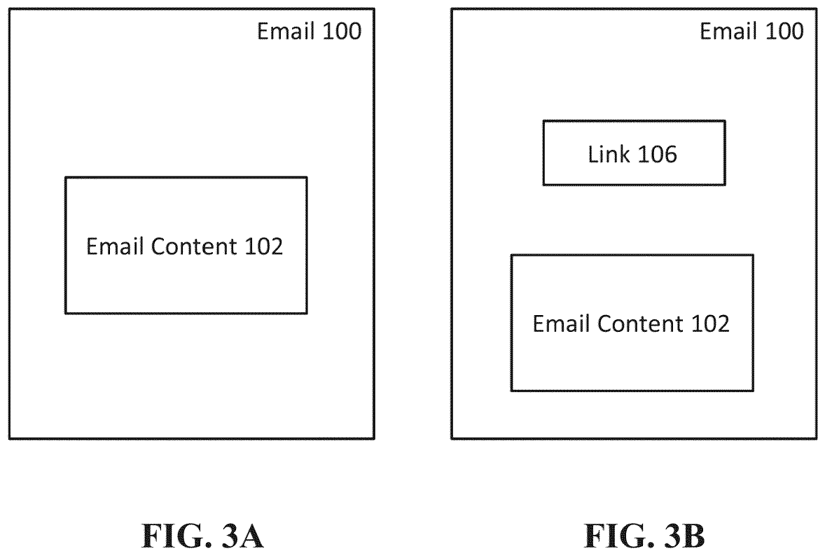

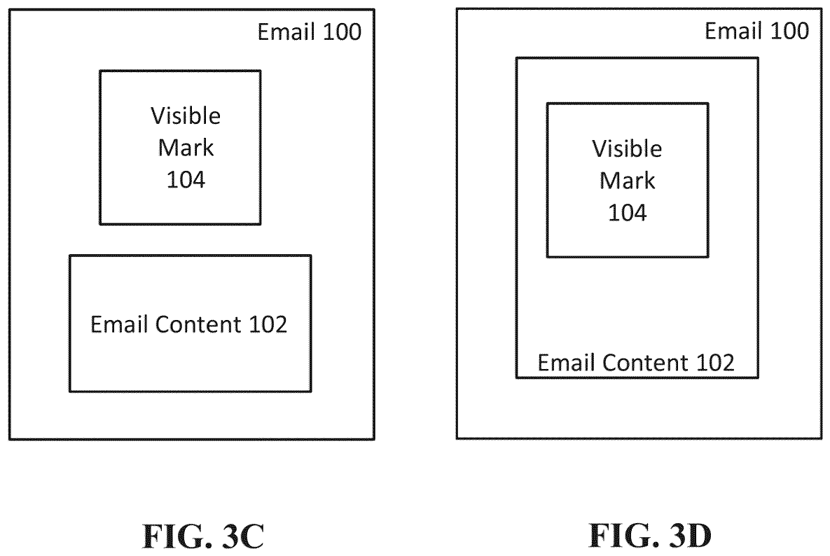

An email 100 which does not include a visible mark is illustrated in FIGS. 3A and 3B. Email 100 including a visible mark 104 is illustrated in both FIGS. 3C and 3D.

In another implementation, the email sent by sending device 10 via a network does not include the visible mark. After being sent by sending device 10, server 20 may add the visible mark to the email and then server 20 sends the email including the visible mark to receiving device 30.

Server 20 receives the email from sending device 10 and sends the email via a network to receiving device 30. In some implementations, the visible mark is included in the received email while in other implementations the server 20 may add the visible mark to the email before sending the email to receiving device 30. Server 20 includes processing circuitry in order to perform these processes, and details of the processing circuitry included server 20 will be discussed later with respect to FIG. 8.

Receiving device 30 receives the email from sending device 10 as sent via server 20. Receiving device 30 includes processing circuitry in order to perform the following processes, and the details of the processing circuitry included receiving device 30 will be discussed later with respect to FIG. 8.

In a case that the email is interacted with or opened by a user of receiving device 30, receiving device 30 may display the email via a display to the user. The user may then view the contents of the email including the visible mark.

When the email is opened, the visible mark is activated, prompting the receiving device 30 to transmit metadata such as sender information, recipient information, date, time, duration of interaction with email or other tracking information to server 20. Such communication is illustrated in FIG. 1.

In an exemplary implementation, transmission of the metadata to server 20 may prompt server 20 to transmit back an image to be inserted into the email for display as the visible mark. Additionally, server 20 may generate a visible mark or adjust image properties of the visible mark, such as size, resolution, color, brightness, contrast, type of image, or other property, based on the metadata transmitted by receiving device 30. For example, the metadata may include properties or settings of the receiving device, such as screen resolution or screen brightness. With such information, server 20 may adjust the image properties of the visible mark to be transmitted back to receiving device 30 for display to increase likelihood of user recognition of the visible mark, indicating that an engagement tracking process is being performed.

Further, server 20 may adjust image properties of the visible mark based on known engagement history (email interaction history, web browsing history or other information) or preferences of the user of receiving device 30. For example, the metadata identifies receiving device 30 to server 20, and server 20 has access to engagement history and preferences of a user of receiving device 30 indicating that the user is colorblind. With this information, server 20 adjusts image properties of the visible mark to be transmitted back to receiving device 30 for display to increase likelihood that the colorblind user recognizes the visible mark, indicating that tracking is being performed.

Activation of the visible mark may prompt receiving device 30 to repeatedly transmit the metadata to server 20 while the email is open or viewed by the user of receiving device 30. As the user scrolls through the email, or interacts with the email by selecting content, links or positions in the email, the visible mark prompts the receiving device 30 to transmit the metadata to server 20. When the email is closed or no longer viewed, the visible mark may cease tracking and receiving device 30 is no longer prompted to transmit the metadata to server 20. In some embodiments, sending device 10 may access and receive the metadata from server 20.

In another implementation as illustrated in FIG. 2, when the email is opened, the visible mark is activated and receiving device 30 is prompted to transmit the metadata to a tracking database 25. Tracking database 25 may include processing circuitry as will be discussed later with respect to FIG. 8. The visible mark may prompt receiving device 30 to repeatedly transmit the metadata to tracking database 25 while the email is open or viewed by the user of receiving device 30, as discussed above with respect to FIG. 1. When the email is closed or no longer viewed, the visible mark may cease tracking and receiving device 30 is no longer prompted to transmit the metadata to tracking database 25.

In some embodiments, sending device 10 may access and receive the metadata from tracking database 25 with communication via a network. Server 20 may communicate with or control tracking database 25. In some embodiments, tracking database 25 is a component of or controlled by server 20. In other embodiments, tracking database 25 is a server or device separate from and not controlled by server 20.

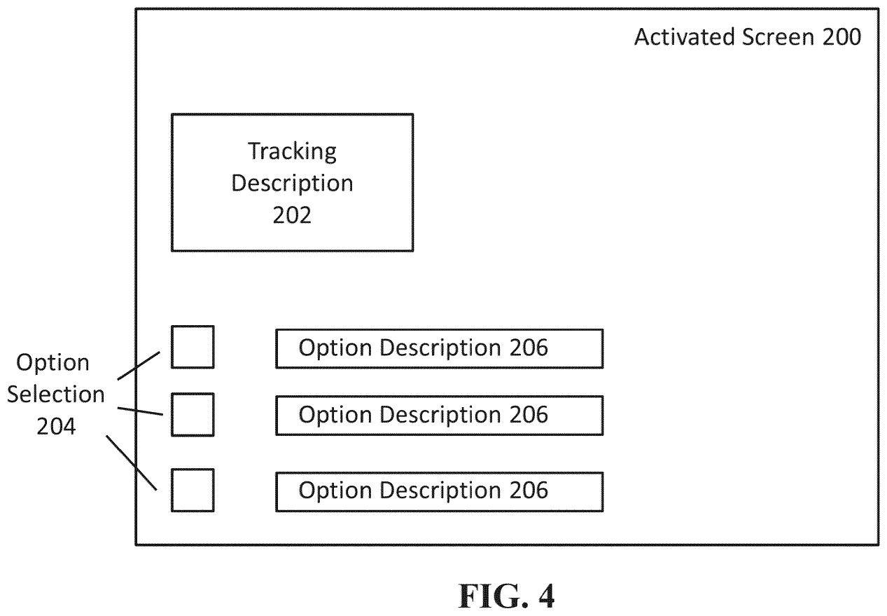

When a user of receiving device 30 interacts with the visible mark, e.g. selects, executes or clicks the visible mark, the receiving device 30 is prompted to display a user interface via a display, as shown by activated screen 200 illustrated in FIG. 4. The user interface may include detailed information about the tracking as well as selectable options to adjust tracking settings. Additionally, the user interface may allow a user to activate or deactivate the tracking as well as select particular third parties, e.g. individuals or companies, in which access to the metadata may be authorized or prohibited.

FIG. 3A illustrates an exemplary email 100 including email content 102. FIG. 3B illustrates an exemplary email 100 including email content 102 and link 106. In an exemplary implementation, link 106 is a URL or other identifier displayed in email 100 and which may be selectable or executable by a user.

FIGS. 3C and 3D illustrate email 100 including email content 102 and visible mark 104. In particular, FIG. 3C illustrates an embodiment in which visible mark 104 is included in email 100 separate from email content 102, while FIG. 3D illustrates an embodiment in which visible mark 104 is included or embedded in email content 102 of email 100.

Sending device 10 may transmit email 100 which includes email content 102. Visible mark 104 may be included in the email 100 sent by sending device 10 or may be added to email 100 by server 20 before sending the email to receiving device 30 or the visible mark may be added to the email after sending the email to receiving device 30.

In an exemplary implementation in which an email 100 includes link 106, a user of receiving device 30 may select or execute the link 106, which prompts receiving device 30 to contact server 20. In response, server 20 may then transmit data corresponding to visible mark 104 back to receiving device 30 for display within email 100.

Image display properties of visible mark 104 may be set by sending device 10 or by server 20. Additionally, image display properties of visible mark 104 may be set or adjusted based on metadata received from receiving device 30. The image display properties of visible mark 104 may be predetermined or adjusted to particular user or particular receiving device properties. The image display properties of visible mark 104 may be set or adjusted based on metadata received from receiving device 104 or based on behavior and engagement history stored by sending device 10, server 20 or tracking database 25.

When the email is displayed, visible mark 104 may be positioned before, after or embedded within the email content 102. The positioning of the visible mark 104 may be adjusted sending device 10 or server 20. In an exemplary implementation, when displayed visible mark 104 is positioned within email 100 so as to increase a likelihood that the user notices the visible mark 104 or recognizes that the visible mark 104 means that tracking is being performed.

FIG. 4 illustrates activated screen 200 displayed by receiving device 30 after visible mark 104 is activated by a user. Activated screen 200 may include tracking description 202 which includes textual discussion or exemplary images about the tracking performed. Tracking description 202 may also include information about what information will be collected, what information has already been collected or who the information is shared with. Tracking description 202 may be a general message or may be specifically tailored to the user that activated visible mark 104 based on the metadata sent by receiving device 30.

Activated screen 204 may also include one or more option selections 204 and option descriptions 206. The option selections 204 may be togglable on or off. Alternatively, the option selections 204 may include a slider or value input to adjust a value, e.g. to adjust a frequency or amount of information to be shared. Each option selection 204 may be provided with a corresponding option description 206 which describes the option as well as a meaning of on/off or each respective value.

One of the options in option selections 204 may allow for activation or deactivation of tracking. Should a user or select or deselect this option, tracking of the user may be respectively activated/deactivated.

Another option of the option selections 204 may relate to what type of information is collected in the tracking. Should a user select, deselect or adjust a slider or value input for this option, settings for tracking of various types of information may be adjusted, e.g. tracking of particular types of information may be authorized or prohibited.

Another option of the option selections 204 may relate to sharing of the tracking information. Should a user select, deselect or adjust a slider or value input for this option, particular third parties or classes/types of third parties may be authorized or prohibited access to the tracking information.

In exemplary implementations, activated screen 200 may include tracking description 202 and option selection 204, may include tracking description 202 without option selection 204 or may include option selection 204 without tracking description 202.

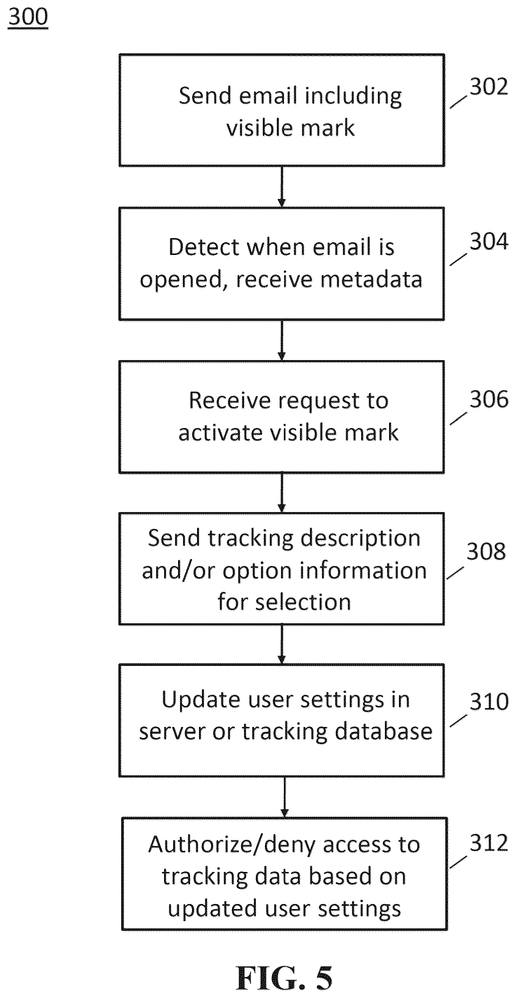

FIG. 5 illustrates process 300 in accordance with the present disclosure.

At step 302, email 100 including visible mark 104 is sent to receiving device 30. In one implementation, sending device 10 sends email 100 including visible mark 104 to server 20 which then sends the email 100 to receiving device 30. In another implementation, sending device 10 sends email 100 to server 20, server 20 inserts mark 104 into email 100 and then server 20 sends the email to receiving device 30.

At step 304, server 20 detects when email 100 is opened by receiving device 30 and server 20 receives metadata. In another implementation, tracking database 25 receives the metadata. Tracking database 25 may transmit a notification to server 20 to notify server 20 that the email has been opened.

At step 306, server 20 receives a request from receiving device 30 to activate visible mark 104. In an exemplary implementation, this request may be sent by receiving device 30 after a user of receiving device 30 selects or clicks visible mark 104.

At step 308, in response to receiving the request, server 20 transmits tracking description 202 and/or option information to receiving device 30. Option information may include option selection(s) 204 and option description(s) 206.

At step 310, user settings are updated in tracking database 25 in response to a user selection of option selections 204. In an exemplary implementation, a user of receiving device 30 may select one or more particular option selections 204, and receiving device 30 may transmit such option selections to server 20. The server 20 may then update user settings stored in server 20. Alternatively, the server 20 may send a transmission to update user settings stored at tracking database 25. In another implementation, receiving device 30 may transmit option selections directly to tracking database 25 so that tracking database 25 may update settings stored at tracking database 25. Based on these settings, tracking of engagement behavior of users may be adjusted, activated, suspended or deactivated. In another implementation, user settings are updated in server 20 in response to the user selection of option selections 204.

At step 312, server 20 may authorize or deny access to tracking data based on the updated user settings. Alternatively, tracking database 25 may authorize or deny access to tracking data based on the updated user settings. In particular, server 20 and/or tracking database 25 may grant or deny access to the tracking data according to the updated user settings. Further, server 20 and/or tracking database 25 may share (by sending or allowing access to) or be prohibited from sharing (by sending or allowing access to) the tracking data with particular third parties based on the updated user settings.

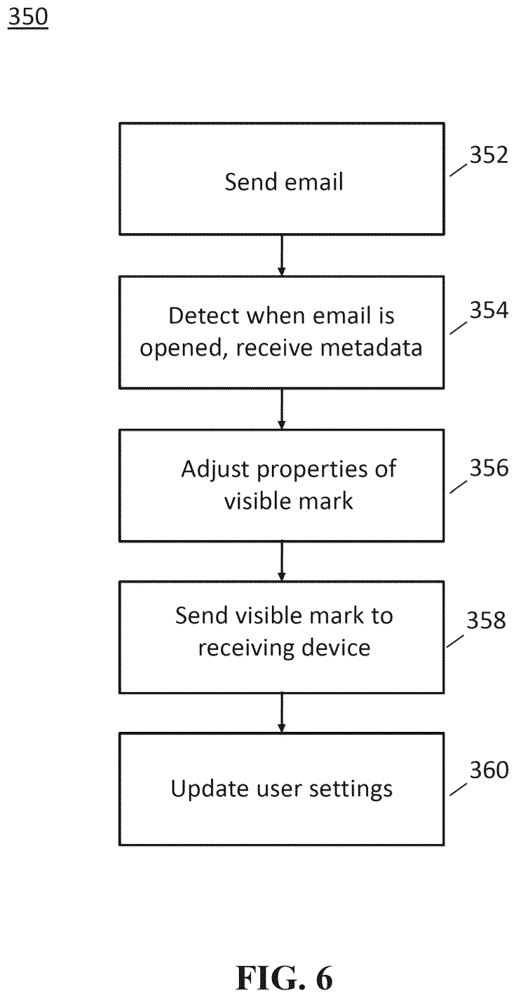

FIG. 6 illustrates process 350 in accordance with the present disclosure.

At step 352, email 100 is sent to receiving device 30. In some implementations, the email 100 received by receiving device includes visible mark 104. Sending device 10 may send email 100 including visible mark 104 to server 20 which then sends the email 100 to receiving device 30. In another implementation, sending device 10 sends email 100 to server 20, server 20 inserts mark 104 into email 100 and then server 20 sends the email to receiving device 30. In other implementations, the email 100 received by receiving device 30 does not include visible mark 104.

At step 354, server 20 detects when email 100 is opened by receiving device 30 and server 20 receives metadata. In another implementation, tracking database 25 receives the metadata. Tracking database 25 may transmit a notification to server 20 to notify server 20 that the email has been opened.

At step 356, server 20 may generate a visible mark 104. For example, server 20 may adjust properties of the visible mark 104 based on information included in the metadata transmitted by receiving device 30. Server 20 may also adjust image properties of the visible mark based on known engagement history (email interaction history, web browsing history or other information) or preferences of the user of receiving device 30 identified by the received metadata.

At step 358, server 20 sends the visible mark 104 from step 356 to receiving device 30.

At step 360, user settings are updated with respect to the properties of visible mark 104. Server 20 may store these updated user settings or the settings may be stored at a remote location such as tracking database 25. The updated user settings may be used later when sending a future email to the user or when sending to receiving device 30 in order to increase likelihood that, when viewing or opening the email, the user notices visible mark 104 or recognizes that the visible mark 104 means that tracking is being performed.

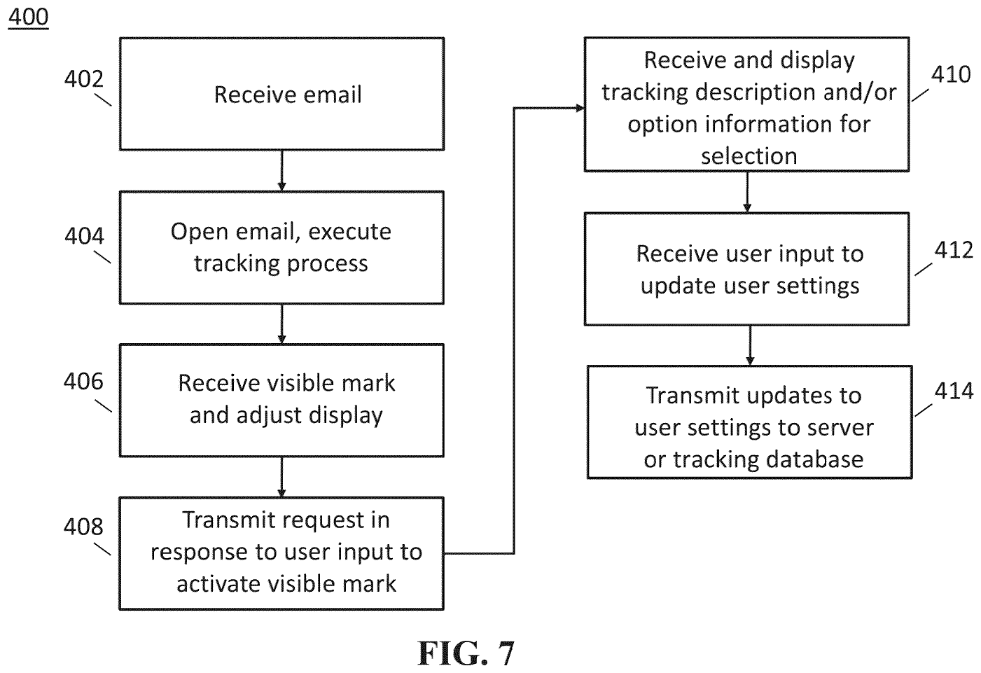

FIG. 7 illustrates process 400 in accordance with the present disclosure.

At step 402, receiving device 30 receives email 100. The email 100 may or may not include visible mark 104. In either case, the email 100 includes an executable code or instruction to prompt receiving device 30 to execute a tracking process.

At step 404, receiving device 30 opens email 100 and executes the tracking process by transmitting metadata to server 20. In other implementations, the receiving device 30 executes the tracking process by transmitting the metadata to tracking server 25.

At step 406, receiving device 104 receives a visible mark 104 from server 20. In a case that the email 100 opened at step 404 already included a visible mark 104, receiving device 30 replaces such visible mark 104 with the visible mark 104 received at step 406. In a case that the email opened at step 404 does not include a visible mark 104, receiving device 30 adjusts a display output of email 100 by inserting the visible mark 104 into email 100.

In some implementations, the process proceeds from step 404 directly to step 408, skipping step 406 because email 100 already includes visible mark 104. In other implementations, the process proceeds from step 404 to step 406 and then to step 408.

When displaying email 100 including visible mark 104, a user of receiving device 30 may select or click visible mark 104 to activate visible mark 104. At step 408, receiving device 30 transmits a request to server 20 in response to the user selecting or clicking visible mark 104.

At step 410, receiving device 30 receives tracking description 202 and/or option information from server 20. Option information may include option selection(s) 204 and option description(s) 206. Receiving device 30 displays the received description 202 and/or option information via activated screen 200.

In some implementations, the request from receiving device 30 may be transmitted to tracking database 25 at step 408, either directly from receiving device 30 or relayed via server 20. Then, at step 410, tracking database 25 may transmit tracking description 202, option selection(s) 204 and option description(s) 206 and transmit visible mark 104 to receiving device 30, either directly or relayed via server 20.

At step 412, the receiving device 30 receives a user input of user selections of option selection(s) 204 to update user settings. At step 414, the receiving device 30 transmits information indicating the user selections to server 20 or tracking database 25.

FIG. 8 is a block diagram of processing circuitry that performs computer-based operations in accordance with the present disclosure. FIG. 8 illustrates processing circuitry 500 of sending device 10, server 20, tracking database 25 and/or receiving device 30.

Processing circuitry 500 is used to control any computer-based and cloud-based control processes, descriptions or blocks in flowcharts can be understood as representing modules, segments or portions of code which include one or more executable instructions for implementing specific logical functions or steps in the process, and alternate implementations are included within the scope of the exemplary embodiments of the present advancements in which functions can be executed out of order from that shown or discussed, including substantially concurrently or in reverse order, depending upon the functionality involved, as would be understood by those skilled in the art. The functionality of the elements disclosed herein may be implemented using circuitry or processing circuitry which may include general purpose processors, special purpose processors, integrated circuits, ASICs (“Application Specific Integrated Circuits”), conventional circuitry and/or combinations thereof which are configured or programmed to perform the disclosed functionality. Processors are processing circuitry or circuitry as they include transistors and other circuitry therein. The processor may be a programmed processor which executes a program stored in a memory. In the disclosure, the processing circuitry, units, or means are hardware that carry out or are programmed to perform the recited functionality. The hardware may be any hardware disclosed herein or otherwise known which is programmed or configured to carry out the recited functionality.

In FIG. 8, the processing circuitry 500 includes a CPU 501 which performs one or more of the control processes discussed in this disclosure. The process data and instructions may be stored in memory 502. These processes and instructions may also be stored on a storage medium disk 504 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other non-transitory computer readable medium of an information processing device with which the processing circuitry 500 communicates, such as a server or computer. The processes may also be stored in network based storage, cloud-based storage or other mobile accessible storage and executable by processing circuitry 500.

Further, the claimed advancements may be provided as a utility application, background daemon, or component of an operating system, or combination thereof, executing in conjunction with CPU 501 and an operating system such as Microsoft Windows, UNIX, Solaris, LINUX, Apple MAC-OS, Apple iOS and other systems known to those skilled in the art.

The hardware elements in order to achieve the processing circuitry 500 may be realized by various circuitry elements. Further, each of the functions of the above described embodiments may be implemented by circuitry, which includes one or more processing circuits. A processing circuit includes a particularly programmed processor, for example, processor (CPU) 501, as shown in FIG. 8. A processing circuit also includes devices such as an application specific integrated circuit (ASIC) and conventional circuit components arranged to perform the recited functions.

In FIG. 8, the processing circuitry 500 may be a computer or a particular, special-purpose machine. Processing circuitry 500 is programmed to execute control processing to control the corresponding device so as to perform the processing and method steps discussed above with respect to FIGS. 1-7. In particular, processing circuitry 500 of sending device 10 executes processing to control sending device 10, processing circuitry 500 of server 20 executes processing to control server 20, processing circuitry 500 of tracking database 25 executes processing to control tracking database 25 and/or processing circuitry 500 of receiving device 30 executes processing to control receiving device 30.

Alternatively, or additionally, the CPU 501 may be implemented on an FPGA, ASIC, PLD or using discrete logic circuits, as one of ordinary skill in the art would recognize. Further, CPU 501 may be implemented as multiple processors cooperatively working in parallel to perform the instructions of the inventive processes described above.

The processing circuitry 500 in FIG. 8 also includes a network controller 506, such as an Ethernet PRO network interface card, for interfacing with network 150. As can be appreciated, the network 150 can be a public network, such as the Internet, or a private network such as a local area network (LAN) or wide area network (WAN), or any combination thereof and can also include Public Switched Telephone Network (PSTN) or Integrated Services Digital Network (ISDN) sub-networks. The network 150 can also be wired, such as an Ethernet network, universal serial bus (USB) cable, or can be wireless such as a cellular network including EDGE, 3G and 4G wireless cellular systems. The wireless network can also be Wi-Fi, wireless LAN, Bluetooth, or any other wireless form of communication that is known. Additionally, network controller 506 may be compliant with other direct communication standards, such as Bluetooth, a near field communication (NFC), infrared ray or other.

The processing circuitry 500 further includes a display controller 508, such as a graphics card or graphics adaptor for interfacing with display 509, such as a monitor. An I/O interface 512 interfaces with a keyboard and/or mouse 514 as well as a touch screen panel 516 on or separate from display 509. I/O interface 512 also connects to a variety of peripherals 518.

The storage controller 524 connects the storage medium disk 504 with communication bus 526, which may be an ISA, EISA, VESA, PCI, or similar, for interconnecting all of the components of the processing circuitry 500. A description of the general features and functionality of the display 509, keyboard and/or mouse 514, as well as the display controller 508, storage controller 524, network controller 506, and I/O interface 512 is omitted herein for brevity as these features are known.

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset.

The functions and features described herein may also be executed by various distributed components of a system. For example, one or more processors may execute these system functions, wherein the processors are distributed across multiple components communicating in a network. The distributed components may include one or more client and server machines, which may share processing, in addition to various human interface and communication devices (e.g., display monitors, smart phones, tablets, personal digital assistants (PDAs)). The network may be a private network, such as a LAN or WAN, or may be a public network, such as the Internet. Input to the system may be received via direct user input and received remotely either in real-time or as a batch process. Additionally, some implementations may be performed on modules or hardware not identical to those described. Accordingly, other implementations are within the scope that may be claimed.

What is claimed is:

1. An apparatus, comprising:
a memory; and
processing circuitry configured to
generate a visible mark associated with an executable code for an engagement tracking process;
insert the visible mark and the executable code into an electronic communication so that the visible mark is accessible in display of the electronic communication; and
transmit the electronic communication, including the visible mark and the executable code, to a user device.

2. The apparatus according to claim 1, wherein the processing circuitry is further configured to receive metadata from the user device based on execution of the engagement tracking process.

3. The apparatus according to claim 1, further comprising a tracking database, wherein
the tracking database receives metadata from the user device based on execution of the engagement tracking process.

4. The apparatus according to according to claim 1, wherein the processing circuitry is further configured to
receive a request, from the user device after activation of the visible mark, and
in response to the request, send description information for display by the user device, the description information relating to the engagement tracking process.

5. The apparatus according to according to claim 2, wherein
the processing circuitry is further configured to
receive a request, from the user device after activation of the visible mark, and
in response to the request, send option information for display by the user device,
the option information including one or more options for selection by a user, and description information relating to each option of the one or more options.

6. The apparatus according to claim 5, wherein the processing circuitry is further configured to
receive user selections from the user device, and
update user settings based on the user selections.

7. The apparatus according to claim 5, wherein the processing circuitry is further configured to control or restrict access to the metadata based on the user settings.

8. The apparatus according to claim 3, wherein
the processing circuitry is further configured to
receive a request, from the user device after activation of the visible mark, and
in response to the request, send option information for display by the user device,
the option information including one or more options for selection by a user, and description information relating to each option of the one or more options.

9. The apparatus according to claim 8, wherein the processing circuitry is further configured to
receive user selections from the user device, and
update user settings based on the user selections.

10. The apparatus according to claim 9, wherein the processing circuitry is further configured to control or restrict access to the metadata based on the user settings.

11. The apparatus according to claim 1, wherein the electronic communication is an email.

12. An apparatus, comprising:
a memory; and
processing circuitry configured to
receive, from a sending device, an electronic communication which includes an executable code for an engagement tracking process; and
transmit the electronic communication to a user device.

13. The apparatus according to claim 12, wherein the electronic communication includes a visible mark associated with the executable code and formatted so that the visible mark is emphasized in display of the electronic communication by the user device.

14. The apparatus according to claim 12, wherein the processing circuitry is further configured to receive metadata from the user device based on execution of the engagement tracking process.

15. The apparatus according to claim 14, wherein the processing circuitry is further configured to
generate a visible mark according to the metadata, the visible mark formatted to be emphasized in display of the electronic communication by the user device, and
transmit the visible mark to the user device.

16. The apparatus according to claim 14, wherein
the electronic communication includes a visible mark associated with the executable code, and
the processing circuitry is further configured to
adjust the visible mark, according to the metadata, to be formatted so that the visible mark is emphasized in display of the electronic communication by the user device, and
transmit the visible mark to the user device.

17. The apparatus according to claim 14, wherein the processing circuitry is further configured to update user settings based on the metadata.

18. A method, comprising:
receiving, by an apparatus from a sending device, an electronic communication which includes an executable code for an engagement tracking process; and
transmitting the electronic communication to a user device.

19. The method according to claim 18, wherein the electronic communication includes a visible mark associated with the executable code and formatted so that the visible mark is emphasized in display of the electronic communication by the user device.

20. The method according to claim 18, further comprising receiving metadata from the user device based on execution of the engagement tracking process.
